(19) United States
(12) Patent Application Publication
(10) Pub. No.: US 2010/0238757 A1
(43) Pub. Date: Sep. 23, 2010

(54) Apparatus, System, and Method for Adding a Liquid in a Mixing Process

(76) Inventor: Michael J. Capps, Cody, WY (US)

Correspondence Address: Kunzler Needham Massey & Thorpe, 8 EAST BROADWAY, SUITE 600, SALT LAKE CITY, UT, 84111, US

(21) Appl. No.: 12/730,071

(22) Filed: Mar. 23, 2010

Related U.S. Application Data
(60) Provisional application No. 61/162,505, filed on Mar. 23, 2009.

(51) Int. Cl. B28C 7/12; B01F 15/06

(52) U.S. Cl. 366/22; 366/145; 366/148

(57) ABSTRACT

An apparatus, system, and method are disclosed for adding a liquid in a mixing process. The apparatus in the described embodiments includes a liquid inlet, a continuous flow heater, a holding tank, a support structure, and a metering device. The continuous flow heater is coupled to the liquid inlet. The holding tank is adapted to be coupled to the continuous flow heater and to receive heated liquid from the continuous flow heater. The support structure is configured to support the holding tank at a height greater than approximately four feet above a ground level. The metering device is coupled to the holding tank and has an indicator for identifying an amount of liquid dispensed from the holding tank.

### CROSS-REFERENCES TO RELATED APPLICATIONS

This application claims the benefit of U.S. Provisional Patent Application No. 61/162,505 entitled “APPARATUS, SYSTEM, AND METHOD FOR ADDING A FLUID IN A MIXING PROCESS” and filed on Mar. 23, 2009 for Michael J. Capps, which is incorporated herein by reference.

### BACKGROUND

1. Field of the Invention

This invention relates to mixing processes and more particularly relates to adding liquids in a mixing process.

2. Description of the Related Art

Many processes involve mixing a liquid with one or more other components to produce a mixed product. For example, water is mixed with Portland cement and sand to produce mortar. In many cases, the amount of liquid in the mixture will have a dramatic impact on the properties of the mixture, and relatively small changes in the amount of liquid can lead to significant changes in mixture properties. The temperature of the liquid may impact the properties of the mixture.

Since mixing processes are often carried out on a worksite where maintaining a consistent mixture and/or fluid temperature are difficult, different batches of mixture may have significantly different properties. This can lead to inconsistent performance of a finished product and/or require changes in application methods of the mixture between batches

For example, when mixing mortar in cold environments, a worker tends a weed burner for warming water and/or mortar. Conventionally, from a crew of masons, at least one man is required to tend one or more weed burners, depending on the size of job. Additionally, weed burners present an open flame with its associated dangers. For example, the weed burner flame is directed at a 55-gallon steel drum to heat the water therein. Typically a crew will utilize two 55-gallon drums and two or three weed burners to heat the water within. Often times the person tending the weed burner touches the barrel to roughly determine the temperature of the water. Checking the temperature by touch can be dangerous.

Furthermore, a mixer operator on the crew typically dips a five-gallon bucket into the 55-gallon heated drum to fill bucket with heated water. This takes much time and labor, and is also dangerous since the mixer operator could come into contact with the drum and/or water, which may be dangerously hot. The process of placing the heated water in the mixing drum is time consuming and strenuous. Additionally, doing so with a bucket is not very accurate, as different buckets of liquid may contain substantially different amounts of liquid.

Another difficulty in conventional methods involves pre-heating the liquid. A mixer operator typically must arrive one hour prior to the first batch of the day in order to warm up the mixer and heat the water. Typically, the operator will direct one weed burner toward a drum of the mixer and one to two weed burners on at least one 55-gallon drum of water. Still further, the operator will need to fill the 55-gallon drum or drums in the first place, which can take 15 to 30 minutes. Thus, it is apparent that much time, labor, and risk are conventionally taken to heat water and mortar.

### SUMMARY

From the foregoing discussion, it should be apparent that a need exists for an apparatus, system, and method that heats and delivers a measured amount of liquid for a mixing process. Beneficially, such an apparatus, system, and method would allow for more consistency between batches of mixed product.

The present disclosure has been developed in response to the present state of the art, and in particular, in response to the problems and needs in the art that have not yet been fully solved by currently available mixing processes. Accordingly, the present invention has been developed to provide an apparatus, system, and method for adding a liquid in a mixing process that overcome many or all of the above-discussed shortcomings in the art.

The apparatus to add a liquid in a mixing process is provided. The apparatus in the described embodiments includes a liquid inlet, a continuous flow heater, a holding tank, a support structure, and a metering device. The continuous flow heater is coupled to the liquid inlet. The holding tank is adapted to be coupled to the continuous flow heater and to receive heated liquid from the continuous flow heater. The support structure is configured to support the holding tank at a height greater than approximately four feet above a ground level. The metering device is coupled to the holding tank and identifies an amount of liquid dispensed from the holding tank

The support structure, in one embodiment, includes an insulated enclosure with a temperature managed region. The holding tank may be located within the temperature managed region. In some embodiments, a space heater is located within the temperature managed region.

The apparatus is further includes, in one embodiment, an outlet valve coupled to the holding tank, the outlet valve having a flow path diameter greater than or equal to approximately three inches. The outlet valve is located within the temperature managed region. The apparatus may also include a liquid outlet coupled to the outlet valve to release liquid from the holding tank.

In a further embodiment, the apparatus includes a controller coupled to the outlet valve. The controller actuates the outlet valve. The controller is positioned outside of the temperature managed region.

In certain embodiments, the outlet valve in operation enables a flow of liquid out of the holding tank at a rate greater than or equal to approximately five gallons per second. In another embodiment, the apparatus includes a pump coupled to the continuous flow heater. The continuous flow heater, in one embodiment, is a first continuous flow heater, and the apparatus also includes a second continuous flow heater coupled to the first continuous flow heater. The second continuous flow heater delivers heated liquid to the holding tank. In another embodiment, the second continuous flow heater is coupled to the liquid inlet.

In some embodiments, the apparatus includes a holding tank inlet valve coupled to the holding tank. The holding tank inlet valve is configured to be moved between a first position for allowing liquid flow from the continuous flow heater into the holding tank and a second position for preventing liquid flow from the continuous flow heater into the holding tank.

The indicator of the metering device, in one embodiment, identifies at least one of a volume, liquid level, or a weight of liquid present in the holding tank. In some embodiments, the apparatus includes a bypass line coupled to the holding tank. The bypass line conducts water from liquid inlet to the holding tank. The apparatus may also include a bypass valve coupled to the bypass line. The bypass valve is configured to be moved between a first position for preventing liquid flow through the bypass line, and a second position for directing liquid flow through the bypass line.

A system of the present invention is also presented to add a liquid in a mixing process. The system may be embodied by a liquid delivery apparatus and an insulated enclosure. In particular, the liquid delivery apparatus, in one embodiment, includes a pump, a continuous flow heater, a holding tank, a support structure, and a metering device.

In one embodiment, the continuous flow heater is coupled to the pump. The holding tank is adapted to be coupled to the continuous flow heater and to receive heated liquid from the continuous flow heater. The support structure may be configured to support the holding tank at a height greater than approximately four feet above a ground level.

The metering device, in one embodiment, is coupled to the holding tank. The metering device identifies an amount of liquid present in the holding tank. The insulated enclosure includes a temperature managed region. The holding tank is located within the temperature managed region.

The system may further include a power source coupled to the pump. The power source may include at least one of a generator, a battery, a solar cell, or a wind turbine. In one embodiment, the pump supplies pressure to the liquid that results in delivering heated liquid to the holding tank at a rate in the range of between about 1 and 15 gallons per minute. Alternatively, the rate is in the range of between about 5 and 10 gallons per minute. The continuous flow heater, in one embodiment, is capable of raising the temperature of the liquid delivered to the holding tank by 90 degrees Fahrenheit.

In some embodiments of the system, the holding tank is a first holding tank, and the system also includes a second holding tank adapted to be coupled to the continuous flow heater and to receive heated liquid from the continuous flow heater. In one embodiment, the system includes an auxiliary heated liquid outlet coupled to the continuous flow heater. The auxiliary heated liquid outlet is located outside the temperature managed region. The system may also include, in one embodiment, a dry material supply bin for supplying at least one of cement, sand, concrete, mix, or gravel to a mixer. The material supply bin may be supported on a support stand that locates the dry material supply bin at a height greater than or equal to approximately three feet from a ground level.

A method of the present invention is also presented for supplying liquid to a mixer. The method in the disclosed embodiments substantially includes the steps necessary to carry out the functions presented above with respect to the operation of the described apparatus and system. In one embodiment, the method includes heating liquid with a continuous flow heater at a rate greater than or equal to approximately five gallons per minute. The method also may include delivering the heated liquid to a holding tank at a rate greater than or equal to approximately five gallons per minute.

In a further embodiment, the method includes managing the amount of liquid in the holding tank to be approximately a predetermined amount. In some embodiments, the method includes delivering the liquid in the holding tank to a mixer at a rate of greater than or equal to approximately five gallons per second. Heating the liquid, in one embodiment, includes raising the temperature by at least ninety degrees Fahrenheit.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a diagrammatic side view illustrating one embodiment of a system for adding liquid in a mixing process;

FIG. 2 is a block diagram depicting one embodiment of a system for adding a liquid such as water in a mixing process;

FIG. 3 is a block diagram depicting one embodiment of another system for adding a liquid such as water in a mixing process;

FIG. 4 is a block diagram depicting one embodiment of another system for adding a liquid such as water in a mixing process;

FIG. 5 is a block diagram depicting one embodiment of a holding tank with several types of metering device for measuring an amount of liquid in the holding tank; and

FIG. 6 is a block diagram illustrating a method for adding liquid in a mixing process.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of user selections, structural variations, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

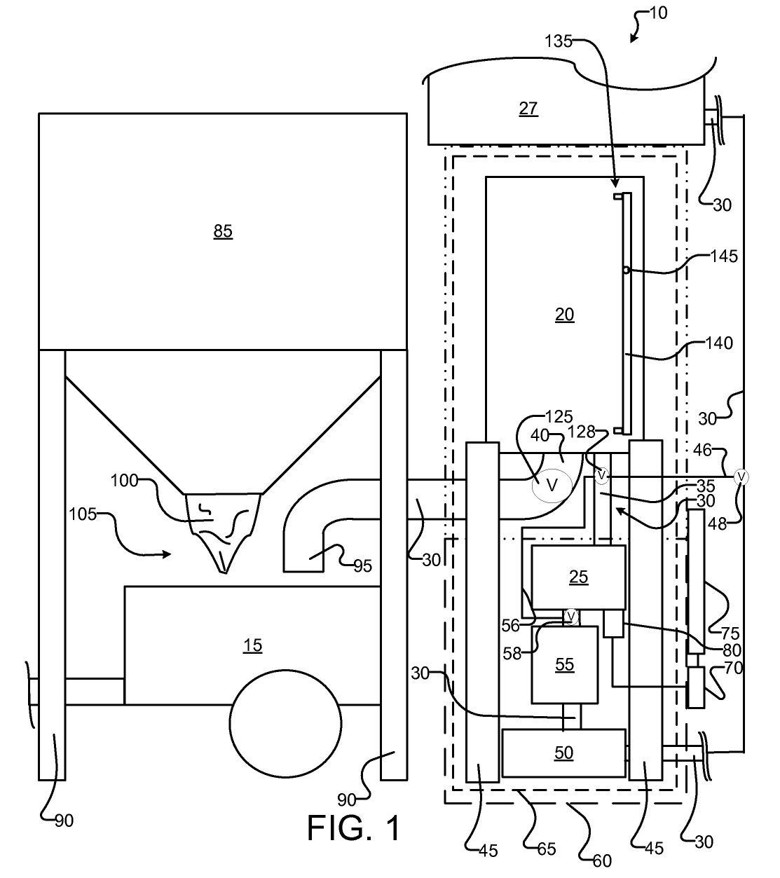

FIG. 1 is a diagrammatic side view of one embodiment of a system 10 for adding a liquid such as water in a mixing process. In particular, the system 10 has a mixer 15 for receiving dry material and a liquid such as water. The mixer 15 can then mix the liquid and dry material to produce concrete, mortar, stucco, grout, or any other blend of cementitious materials. The quality of the blend depends at least in part on a temperature of the materials and the resulting blend. A holding tank 20 for liquid may receive conditioned liquid such as conditioned water. The conditioning may include heating or cooling. The holding tank 20 may be insulated in order to facilitate heat retention in the liquid or exclude heat transfer to the liquid within the holding tank 20. In one example, the liquid is water that comes from underground and may have a temperature at or around 40 degrees F. Ambient temperature of outside air may be between 0 and 20 degrees F. Where an ideal temperature for mortar to be mixed is between 70 and 80 degrees F., the system 10 is utilized to raise the temperature to a maximum or near maximum temperature at which the mortar can function properly in laying brick or block. Thus, water is heated to approximately 110 degrees F. and is supplied to the holding tank 20 at or near that temperature.

Alternatively, the temperature of the water may be raised to 120 degrees F. such that in the short cooling time during filling of the holding tank 20, the temperature only falls by 10 or 12 degrees F. to approximately 110 degrees F. In this way, even though cooling of the water occurs due to conductive and convective heat transfer to the atmosphere, an ideal temperature for the mortar is reached at approximately the time when the mortar is being utilized for bricking or blocking a structure. That is, the timing of adding the water or other liquid, mixing, transporting and placing the mortar on mud boards is approximately right for allowing the temperature of the blend of water and dry material to reach a range from 70 to 80 degrees F. In some cases, the range is from 40 to 110 degrees F. In any case, an acceptable temperature for the mortar is achieved at the time the mortar is to be used.

In order to heat the water or other liquid to the desired temperature, in one embodiment, a continuous flow heater 25 is coupled to the holding tank 20 by a line 30 extending upstream from the holding tank 20 and downstream to the holding tank 20 from a liquid supply. A continuous flow heater 25 is a heater that heats a liquid as the liquid flows through the heater. Continuous flow heaters are also known as “tankless” or “instantaneous” heaters. Other heat exchangers may be utilized without limitation. One continuous flow heater 25 that may be employed for this purpose is the Bosch AquaStar, Model 2700 ES, having an output capacity of 199k BTU. Other heaters may be alternatively or additionally utilized.

The line 30 may be any type of line capable of transmitting liquid. For example, the line 30 may be copper pipe. In an alternative embodiment, the line 30 may be cross-linked polyethylene (PEX) pipe.

In an alternative embodiment, the system 10 may chill the liquid. A system that lowers the temperature of the liquid may be used to maintain desirable temperature of the liquid in a mixing process when the liquid or the ambient environment has a temperature that is higher than the desired temperature. The system 10, in one embodiment, includes a chiller (not shown) that chills the liquid as the liquid flows through the chiller.

The liquid supply may include water or other liquid from a pressurized source such as underground piping or a pressurized tank. Alternatively, the liquid source may include a reservoir 27 that is filled and transported to a construction site. This reservoir 27 may have a capacity of 350 gallons or more, such that more than ten batches of mortar or concrete may be made without refilling the reservoir 27. In some embodiments, the reservoir 27 is unmeasured, such that a worker may deliver liquid to the reservoir 27 without being concerned about the exact amount of liquid in the reservoir 27. In certain embodiments, the reservoir 27 is exposed to the ambient environment, such that the temperature of the liquid in the reservoir 27 is unmanaged.

As shown in FIG. 1, the reservoir 27 may be supported above the holding tank 20, may be coupled to a line 30, and may be part of the system 10. The line 30 may have an inlet 35 and an outlet 40 coupled to the holding tank 20 at upstream and downstream locations, respectively. As shown, the outlet 40 and the line 30 extending downstream from the holding tank 20 may have a large diameter to enable high flow rates from the holding tank 20 into the mixer 15. For example, the outlet 40 and corresponding line 30 may have a flow path diameter of approximately three inches. Alternatively expressed, a cross-sectional area taken on a plane transverse to a direction of flow in the outlet 40 may have a size of approximately twelve square inches. Diameters for the outlet 40 and the corresponding line 30, in some embodiments, may be in a range from three to ten inches. The outlet 40 and line 30 may have other than round cross-sectional areas, and may have areas corresponding to this range of diameters. In other embodiments, outlets 40 and lines 30 may have areas of greater or lesser sizes.

In some embodiments, the line 30 extending downstream from the holding tank 20 may extend horizontally a distance up to approximately ten feet. However, some embodiments have shorter lengths in this downstream portion of line 30 since there is less surface area through which heat transfer to or from the liquid inside may occur. Similarly, some embodiments vertically locate the outlet line 30 near the mixer, thus reducing heat transfer to or from the liquid.

The continuous flow heater 25, in certain embodiments, may be any of a variety of tankless or instantaneous heater that is capable of heating water and raising the temperature 70 degrees Fahrenheit at a rate of five gallons per minute (GPM). This example is for an elevation of approximately 5,000 feet above sea level and starting with a water temperature of 40 degrees F. Such a heater is capable heating water through a 70 degree increase at a rate of 8 GPM when utilized at sea level. In an alternative embodiment, the continuous flow heater 25 may be any type of continuous flow heater capable of heating water and raising the temperature ninety degrees Fahrenheit at a rate of five GPM.

In one embodiment, by utilizing two such heaters in supply line(s) 30 to the holding tank, the rate may be doubled to ten GPM. Three heaters may be used to triple the rate, and so forth without limitation of the number of heaters that can be utilized in the system 10. At these rates it is possible to supply heated water or other liquid substantially on demand for a crew of masons at a building site. Alternatively, a larger capacity heater may replace two or more smaller heaters.

With the continuous flow heater 25, in some embodiments, the rate at which the holding tank 20 can be filled is substantially the same as the rate at which the liquid is heated. Therefore, the holding tank 20 can be filled at approximately five GPM, ten GPM, fifteen GPM, etc. depending on the number and type of continuous flow heaters 25 incorporated. Thus, if the holding tank 20 has a capacity of twenty gallons, it will only take approximately four minutes to fill the holding tank 20 utilizing a single continuous flow heater 25. If the holding tank is set for a capacity of 25 gallons, on the other hand, the heater will fill the holding tank 20 in approximately five minutes.

In one embodiment, the method includes providing iterations of refilling the holding tank 20 every five minutes. The capacity of the holding tank 20 may be adjustable from fifteen gallons to thirty gallons. As discussed above, the outlet 40 and line 30 extending downstream from the outlet 40 is large to enable quick release or flushing of the liquid from the holding tank 20 into the mixer 15. A port through a top wall of the holding tank 20 allows free passage of air into the holding tank 20 to replace the liquid as it flushes out. This port may have a large diameter, such as a four-inch diameter.

In one embodiment, the rates at which the liquid is flushed may be in a range from one to five seconds for the range of capacities from fifteen to thirty gallons. For example, flushing 25 gallons through a four-inch diameter outlet may take four seconds. Thus, the transfer of liquid from the holding tank 20 into the mixer 15 is relatively quick. This has the benefit of reducing the time during which the liquid is loosing heat to the atmosphere during transfer of the liquid to the mixer 15.

To facilitate the rapid flow from the holding tank to the mixer, in some embodiments, the holding tank 20 is supported in an elevated position by a support structure 45. The support structure 45 may be adjustable in height to accommodate delivery to different mixer/system configurations and to adjust the pressure with which the liquid is fed from the holding tank 20.

In one embodiment, the liquid is gravity fed from the holding tank 20. Additionally or alternatively, a pumping system may be utilized to transfer the liquid from the holding tank 20. Positioning of the holding tank 20 above the mixer 15 at a certain height and/or providing a particular holding tank 15 configuration can enable flushing at a certain rate. In one embodiment, flushing may take up to ten seconds or more.

When no heating of the water is needed, some embodiments include a bypass line 46 to divert water from the source such as reservoir 27 into the holding tank 20 without passing through the continuous flow heater 25. Alternatively stated, the bypass line 46 may be coupled to the holding tank 20 upstream and downstream of the continuous flow heater 25 to bypass at least the continuous flow heater 25. At least one bypass valve 48 may be placed in the line 30 at the junction coupled to the bypass line 46 upstream of the tankless heater 25. The bypass valve 48 may be configured to be moved between a first position for directing liquid flow through the heater 25, and a second position for directing liquid flow through the bypass line 46, as shown in FIG. 1. Thus, a user may selectively open or close the bypass valve 48 in order to direct the liquid from the source either directly into the holding tank 20 or via other components. By bypassing the continuous flow heater 25 and/or other components, a rate of flow for the liquid may be increased to approximately ten gallons per minute in one embodiment. This flow rate may be induced by a pump, gravity feed, or other pressurized system where the system 10 for adding heated water is rated, for example, at 80 psi maximum capacity.

The system 10, in one embodiment, includes a pump 50 receiving liquid from upstream in the line 30 and delivering the liquid under pressure downstream through the line 30 to an expansion tank 55, which is basically a pressure regulator tank. This pump 50 and expansion tank 55 may be used when the liquid is drawn from a non-pressurized source at an elevation equal to or lower than the holding tank 20. In an alternative embodiment, the system includes a pump 50 that delivers liquid to the continuous flow heater 25, but not an expansion tank.

If the source includes the reservoir 27 at a raised position, the pump 50 and/or expansion tank 55 may be omitted. Rather, the elevation of the reservoir 27 provides sufficient head to move the liquid through the tankless heater 25 and into the holding tank 20. For this purpose, the support structure may be configured to support the holding tank 20 at a height in a range from approximately 48 inches to approximately 108 inches from a base of the mixer 15 to the flow line 30 extending from the holding tank 20. The holding tank 20 extends above the flow line 30 in one embodiment. In some embodiments, the holding tank 20 may be elevated as much as 240 inches in order to provide increased pressure and flow rate out of the holding tank 20.

When the pump and/or expansion tank 55 are needed, in one embodiment, another bypass line 56 is coupled upstream and downstream of the tankless heater 25, as shown in FIG. 1. Once again, at least one bypass valve 58 is placed in line 30 at a junction coupling the bypass line 56 to the line 30 for selectively directing the liquid from the pump 50 and/or expansion tank 55 into the holding tank 20 without passing through the tankless heater 25.

In one embodiment, the reservoir is supported atop an enclosure 60, which may take the form of a construction shed, for example. The enclosure 60 may be supported atop the support structure 45, as indicated by a broken chain dashed line. Alternatively, the support structure 45 may include the enclosure 60 and extend substantially to a ground level, as indicated by a long dash. The enclosure 60 is also represented by two types of dashed lines indicating that any number of the several components shown may be surrounded by the enclosure 60. In one embodiment, the enclosure 60 surrounds only the holding tank 20. Furthermore, the enclosure 60 may support the holding tank 20 at an elevated position. The enclosure 60 may be insulated by a layer of insulation material 65. Thus, heat transfer out of the holding tank 20 and/or other components of the system 10 is inhibited.

Protecting the holding tank 20 and/or other components in the enclosure 60 in this manner enables, for example, leaving water in the holding tank 20 overnight even when the temperature outside is ten degrees Fahrenheit below zero. Thus, there is less need for weatherproofing, which otherwise is needed on a nightly basis in cold weather. In an alternative embodiment, the holding tank 20 may include heating coils within or in contact with the holding tank 20 that actually aid in heating or at least maintaining the heat in the liquid within the holding tank 20.

By using gravity feed from a raised reservoir 27 and enclosing the holding tank 20, very little power is required to run the system 10. In fact, the system 10, in some embodiments, can be run on a twelve or twenty-four volt direct current (DC) power supply 70, which may include batteries that can be recharged by solar power through a solar cell 75, for example. In another example, the power supply 70 may be powered by a wind turbine. Instead of a continuous pilot light for the tankless heater 25, an electronic ignition 80 could be connected to the power supply 70 to enable start-up of the continuous flow heater 25 as needed.

In some embodiments, the reservoir 27, the holding tank 20, and the continuous flow heater 25 may be transported as a unit on a truck or trailer Likewise, other components needed for the dry materials may be supported on a truck or trailer. Thus, the entire system 10 may be a whole portable concrete plant. For example, the enclosure 60 with all of its contents may be supported on a bed of a truck. The reservoir 27 may be supported on the enclosure during transport, or may be separately supported on the truck. The reservoir 27 and the enclosure 60 may include fork pockets for receiving feet of a forklift during placement at a construction site. The enclosure 60 or other structure may have fork pockets on all four sides. Alternatively, the truck may provide the support structure for supporting the holding tank 20 and/or reservoir 27 in an elevated position.

Like the holding tank 20, a bin or silo 85 for holding the dry material may be supported on adjustable legs 90 or other structure. Thus, the height of the silo 85 can be adjusted to receive the mixer 15 thereunder. A height from a base of the mixer 15 to a dispensing outlet 105 of the silo 85 may be in a range from approximately 36 inches to approximately 120 inches. The main body of the silo 85 extends upwardly from its dispensing outlet 105. In some cases, the main body may reach to heights of 240 inches or more and may be connected to an outlet by an elongate tube or funnel.

The silo 85, in one embodiment, has a capacity sufficient to hold four or five bulky bags, which are three foot by three foot by three foot of preblended mortar or grout mix. The silo 85 may also have a gravity feed system with a valve or door connected with a lever that can be manually pulled to let the dry material pass out of the silo 85.

In some embodiments, the silo 85 and its support structure can be transported on a truck. Alternatively, a truck or trailer may provide the needed support for the silo 85. In any case, the silo 85 and the holding tank 20 are positionable in order to place a liquid outlet 95 of the outlet line 30 from the holding tank 20 and a sock 100 forming a dispensing outlet 105 above the mixer 15. By locating the liquid outlet 95 and the dispensing outlet 105 in close proximity to each other, the flow of liquid quickly moistens the dry material and reduces the dust that otherwise is generated and escapes during adding and mixing.

In some applications the liquid is completely discharged into the mixer 15 prior to adding the dry material. In other embodiments, the liquid is discharged in a controlled manner to improve a quality of the cementitious mixture. Also, adding the water more gradually may help to control the dust from the dry material more effectively. In an alternative embodiment, the liquid is directed into the mixer 15 concurrently with dry mix from the silo 85. For example, the liquid may be dispensed by the system 10 into an auger (not shown) configured to continuously mix dry mix with the liquid and transport the mixture to a receptacle (not shown). In this example, the amount of liquid injected into the auger is metered by the system 10 to be at a predetermined flow rate that corresponds to a rate at which dry mix is introduced into the auger.

The outlet 40, in one embodiment, may include an outlet valve 125 for actuating a flush from the holding tank 20. The outlet valve 125 may be a ball valve, butterfly valve, gate valve, or other mechanism for enabling quick release of the liquid inside the holding tank 20 when actuated.

In some embodiments, a metering device 135 is connected to the holding tank 20. The metering device 135 measures an amount of liquid in the holding tank 20. In one embodiment, the metering device 135 includes a transparent tube 140 that extends vertically along an exterior of the holding tank 20 and which is liquidly coupled to an interior thereof.

In one embodiment, a floating element 145 is isolated for vertical movement within the transparent tube 140 on the surface of the liquid that is permitted to rise and fall together with the rise and fall of the liquid within the holding tank 20. The floating element 145 acts as an indicator to indicate the amount of liquid in the holding tank 20 The metering device 135 can be calibrated by weight or volume of liquid, and marks can be placed on the transparent tube 140 and/or tank 20 wall indicating any of a variety of increments of the weight or volume. For example, the marks may be placed to indicate 1, 2, 3, 5, 10, 15, 20, 25, 30 gallon or other increments.

Measuring the water accurately is critical in some applications. For example, when color is added to mortar, a change in proportions of the ingredients, which may include water proportions, can change the color of the mortar and the appearance of the building in which the mortar is being used. The accuracy of the water measurement can also affect the quality of the mortar, stucco, or concrete. Therefore, accurate marks associated with the metering device 135 and the ability of a user or an automated system to accurately stop and start pumping is another feature of some embodiments.

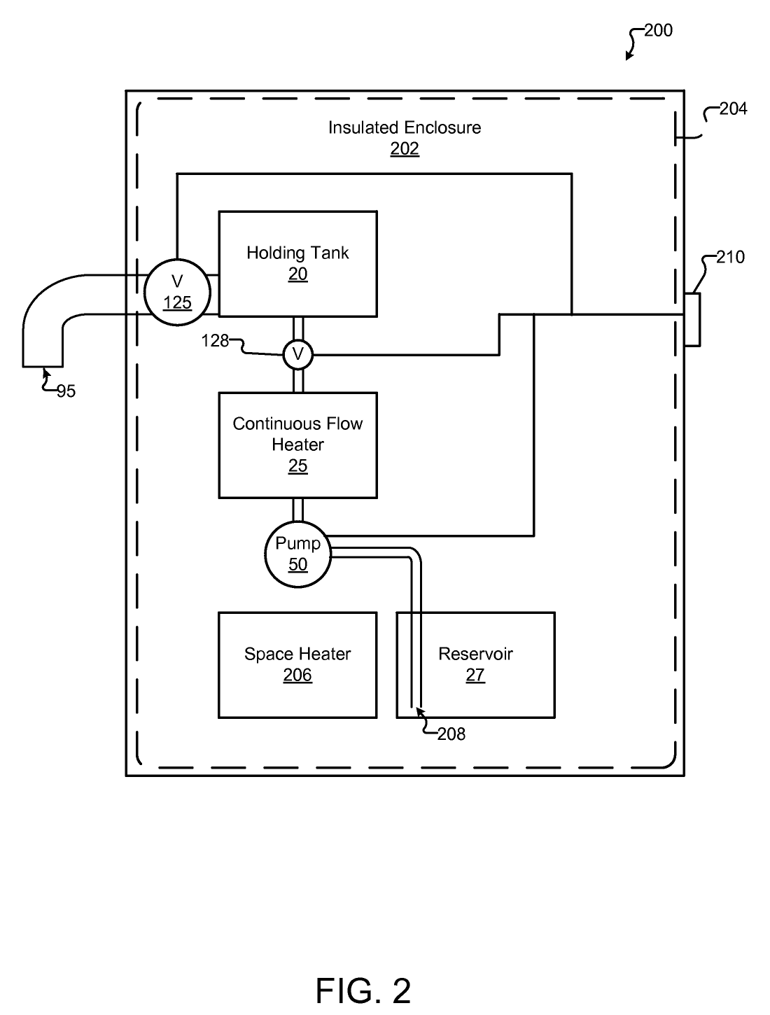

FIG. 2 is a block diagram depicting one embodiment of a system 200 for adding a liquid such as water in a mixing process. The system 200 includes an insulated enclosure 202, a space heater 206, a controller 210, a reservoir 27, a pump 50, a continuous flow heater 25, and a holding tank 20. The system 200 heats a liquid, moves the liquid to the holding tank 20, and dispenses the liquid for use in a mixing process.

In some embodiments, the insulated enclosure 202 is a rigid or semi-rigid structure that contains one or more components of the system 200. Components of the system 200 are attached to and supported by the insulated enclosure 202, in some embodiments. The insulated enclosure 202 may be any type of enclosure large, strong, and rigid enough to contain and support one or more components of the system 200. For example, the insulated enclosure 202 may be constructed of corrugated steel walls lined with a layer of foam insulation. In a further embodiment, the insulated enclosure 202 is portable and has attachment points that, for example, allow a fork lift to pick up, move, and position the insulated enclosure.

In an alternative embodiment, components of the system 200 are supported by scaffolding (not shown). The scaffolding, in some embodiments, is a collection of components that may be assembled for use and disassembled for transport. Components of the system 200 may be attached to and supported by the scaffolding.

The insulated enclosure 202, in one embodiment, encloses a temperature managed region 204. The temperature managed region 204 may contain one or more components of the system 200 and protect the contained components from extremes in temperature. For example, the system may be used in a location where the temperature is below the freezing point of the liquid used in the mixing process. In this example, the temperature managed region 204 may be maintained at a temperature above the freezing point of the liquid, thus protecting components in the temperature managed region 204 from damage that could otherwise be caused by freezing liquid.

In some embodiments, the space heater 206 heats the temperature managed region 204. Any type of space heater 206 may be used. For example, the space heater 206 may be an electric forced air heater, a gas-fired radiant heater, or a radiator supplied with heated water. The space heater 206, in one embodiment, is controlled by a thermostat that manages the heat output of the space heater 206 to maintain a desired temperature within the temperature managed region 204.

In an alternative embodiment, the system 200 includes an air conditioner (not shown). The air conditioner cools the air within the insulate enclosure 202 and lowers the temperature within the temperature managed region 204. Lowering the temperature in the temperature managed region 204 may be useful when the system 200 is used in an ambient environment having a relatively warm temperature or when the input liquid is at a temperature that is higher than a desired liquid temperature.

In one embodiment, the system 200 includes a reservoir 27 containing a liquid. The reservoir 27 may be disposed within the temperature managed region 204. In one embodiment, the reservoir 27 is unpressurized and the liquid in the reservoir is accessed by a liquid inlet 208. For example, the reservoir 27 may be a tank placed on a floor of the insulated enclosure 202.

The pump 50, in one embodiment, draws liquid from the reservoir 27 and supplies the liquid to other components of the system 200. The pump 50 may be any pump capable of forcing the liquid through the components of the system 200. In one embodiment, the pump 50 is a centrifugal pump disposed external to the reservoir 27. In an alternative embodiment, the pump 50 is submerged within the liquid in the reservoir 27.

The continuous flow heater 25, in certain embodiments, receives liquid driven by the pump 50 and heats the liquid to a desired temperature as it flows through the continuous flow heater 25. In some embodiments, the continuous flow heater 25 is regulated by a thermostat that switches the continuous flow heater 25 between an on state and an off state to maintain the desired liquid temperature. In an alternative embodiment, the continuous flow heater 25 has a variable heating rate, and the desired liquid temperature is maintained by varying the heating rate. In yet another embodiment, the desired liquid temperature is maintained by managing a flow rate through the continuous flow heater 25.

The continuous flow heater 25 may be any type of continuous flow heater capable of heating the liquid to a desired temperature. For example, the continuous flow heater 25 may be a gas fired heater, or alternatively, any suitable continuous flow water heater such as electric or solar heated.

The continuous flow heater 25 delivers liquid to the holding tank 20, in one embodiment. In some embodiments, the flow of liquid into the holding tank 20 is controlled by a holding tank inlet valve 128. The holding tank inlet valve 128 may be any type of valve capable of switching between a state or position that allows liquid to flow into the holding tank 20 and a state or position that restricts or prevents a flow of liquid into the holding tank 20. For example, the holding tank inlet valve 20 may be a ball valve.

In one embodiment, the holding tank inlet valve 128 may be closed in preparation for or in conjunction with flushing the holding tank 20. With the holding tank inlet valve 128 closed, water cannot be drawn through the holding tank inlet valve 128 to increase the amount of liquid flushed from the holding tank 20. Since additional liquid is not drawn into the holding tank 20 when the holding tank inlet valve 128 is closed, the amount of liquid flushed from the holding tank 20 may be more precisely controlled.

In one embodiment, the holding tank 20 may be any type of vessel capable of holding an amount of liquid required to mix a batch of mixed material. For example, the holding tank may have a capacity of 25 gallons, and a mixing process that uses the holding tank 20 may require 23 gallons. The holding tank 20 may be supported by the insulated enclosure 202 in one embodiment and positioned inside the insulated enclosure to provide a gravity flow for dispensing the liquid. In other words, the holding tank 20 is positioned at a height higher than the mixer 15 of FIG. 1.

The outlet valve 125, in some embodiments, manages a flow of liquid out of the holding tank 20 to be dispensed for a mixing process. The outlet valve 125 is disposed between the holding tank 20 and the liquid outlet 95.

The holding tank inlet valve 128 and the outlet valve 125 are disposed within the temperature managed region 204 in one embodiment. By positioning the holding tank inlet valve 128 and the outlet valve 125 within the temperature managed region 204, the valves 128, 125 are protected from damage due to freezing liquid.

In some embodiments, the holding tank inlet valve 128 and/or the outlet valve 125 are controllable from outside of the insulated enclosure 202. For example, the outlet valve 125 may be controlled via a mechanical actuator connected to a lever outside of the insulated enclosure. In an alternative embodiment, holding tank inlet valve 128 and/or the outlet valve 125 controlled by electrical actuators. For example, the outlet valve 125 may be controlled via a controller 210 in electrical communication with the outlet valve 125. The controller 210, in one embodiment, is disposed on an outer surface of the insulated enclosure 202. A controller 210 located outside of the temperature managed region 204 may reduce a number of times that an entrance to the insulated enclosure 202 is opened, and result in more efficient management of temperature within the temperature managed region 204. The controller 210, in a further embodiment, displays the amount of liquid remaining in the holding tank and the amount of liquid that has been dispensed.

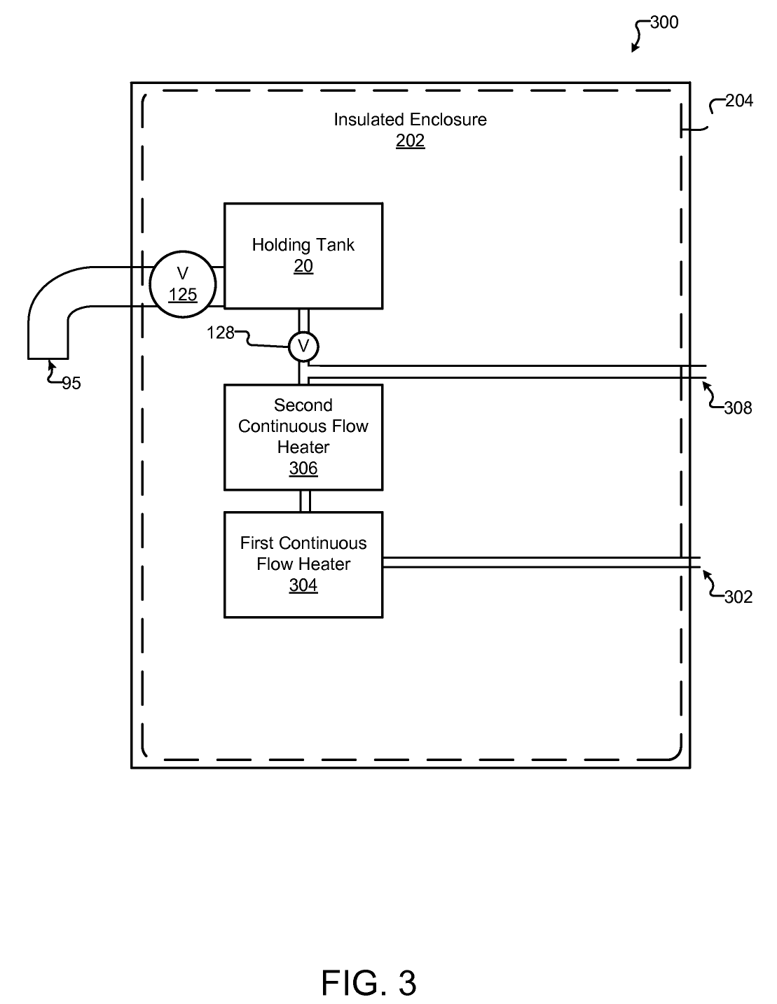

FIG. 3 is a block diagram depicting one embodiment of another system 300 for adding a liquid such as water in a mixing process. The system 300 includes a liquid inlet 302, a first continuous flow heater 304, a second continuous flow heater 306, a holding tank inlet valve 128, a holding tank 20, an outlet valve 125, a liquid outlet 95, and an auxiliary heated liquid outlet 308. The system 300 heats a liquid, moves the liquid to the holding tank 20, and dispenses the liquid for use in a mixing process.

In one embodiment, the liquid inlet 302 receives liquid for use in the system 300. The liquid inlet 302 may be located outside of the insulated enclosure 202 to receive a liquid from a source external to the system. For example, the liquid inlet 302 may receive liquid from a pressurized liquid source (not shown), such as a fire hose.

The liquid inlet 302 may include a liquid inlet valve (not shown) that manages the flow of liquid into the system 300. The liquid inlet valve, in one embodiment, is a frost-free valve. The liquid inlet valve may include a valve mechanism disposed within the temperature managed region 204. The liquid inlet valve may include a control that is outside of the temperature managed region 204.

In some embodiments, the liquid inlet 302 is in liquid communication with the first continuous flow heater 304. Liquid from the liquid inlet 302 is delivered to the first continuous flow heater 304. The first continuous flow heater 304 heats liquid as it passes through the first continuous flow heater 304.

The second continuous flow heater 306, in some embodiments, is arranged in series with the first continuous flow heater 304 and further heats liquid previously heated by the first continuous flow heater 304. By arranging multiple continuous flow heaters 304, 306 in series, the system 300 can increase a delivery rate of heated liquid and/or increase a temperature of heated liquid.

In an alternative embodiment, the first continuous flow heater 304 and the second continuous flow heater 306 may be arranged in parallel, such that liquid is heated by either the first continuous flow heater 304 or the second continuous flow heater 306 and passes into the holding tank 20. By arranging multiple continuous flow heaters 304, 306 in parallel, the system 300 can increase a delivery rate of heated liquid. An alternative embodiment may include a recirculating tube to feed heated liquid back into the continuous flow heater for a second “heating.”

In one embodiment, the auxiliary heated liquid outlet 308 receives heated liquid from the second continuous flow heater 306 and provides a source of heated liquid for other uses. For example, in a particularly cold environment, the auxiliary heated liquid outlet 308 may dispense heated liquid for cleaning tools. The auxiliary heated liquid outlet 308 includes an auxiliary valve (not shown) in some embodiments. In one embodiment, the auxiliary valve is a frost-free valve.

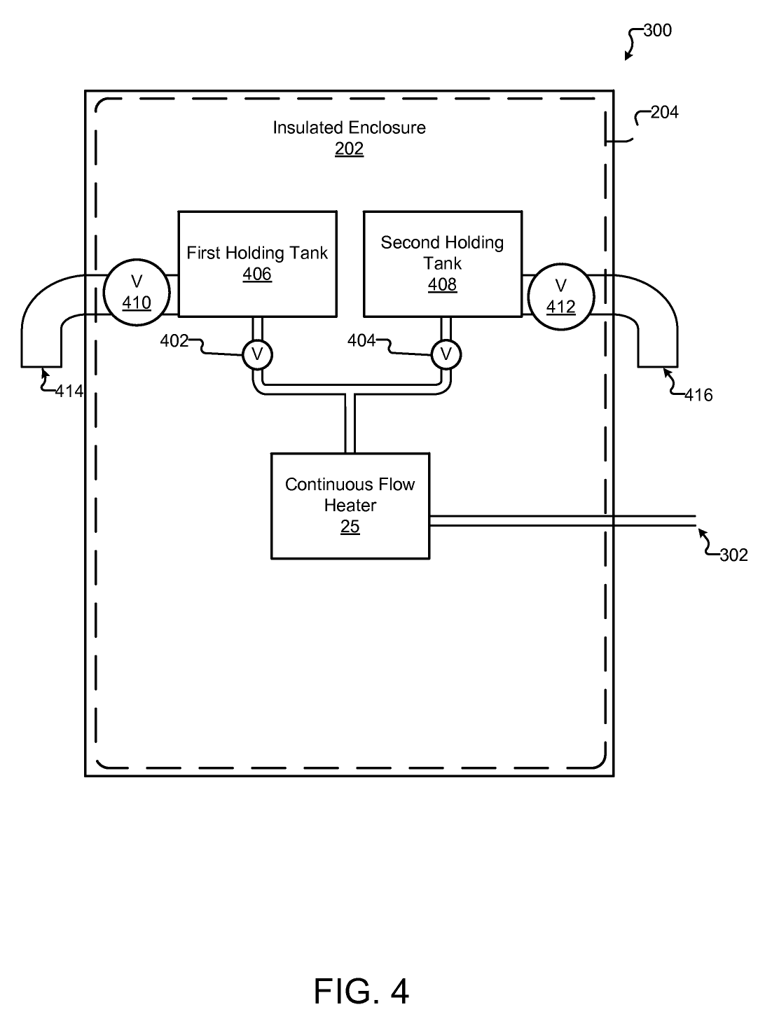

FIG. 4 is a block diagram depicting one embodiment of another system 400 for adding a liquid such as water in a mixing process. The system 400 includes an insulated enclosure 202, a temperature managed zone 204, a liquid inlet 302, a continuous flow heater 25, a first holding tank inlet valve 402, a second holding tank inlet valve 404, a first holding tank 406, a second holding tank 408, a first outlet valve 410, a second outlet valve 412, a first liquid outlet 414, and a second liquid outlet 416. The system 400 heats a liquid, moves the liquid to the first holding tank 406 and/or the second holding tank 408, and dispenses the liquid for use in a mixing process.

In some embodiments, the first holding tank inlet valve 402 and the second holding tank inlet valve 404 are similar to the holding tank inlet valve 128 described previously. Additionally, in certain embodiments, the first holding tank 406 and the second holding tank 408 are similar to the holding tank 20 described previously. Furthermore, in some embodiments, the first outlet valve 410 and the second outlet valve 412 are similar to the outlet valve 125 described previously. The first liquid outlet 414 and the second liquid outlet 416 are, in certain embodiments, similar to the liquid outlet 95 described previously.

The continuous flow heater 25, in one embodiment, provides heated liquid to the first holding tank 406 and/or the second holding tank 408. A flow of liquid into the first holding tank 406 and/or the second holding tank 408 is regulated by the first holding tank inlet valve 402 and/or the second holding tank inlet valve 404. The first holding tank inlet valve 402 and the second holding tank inlet valve 404 may each be switched between a position or state that allows liquid flow to pass through the valve and into the respective holding tank and a position or state that restricts the flow of liquid through the valve. By manipulating the positions or states of the first holding tank inlet valve 402 and the second holding tank inlet valve 404, heated liquid may be directed into the first and/or second holding tanks 406, 408 as required.

In one embodiment, the first outlet valve 410 and the second outlet valve 412 regulate a flow of liquid out of the first and second holding tanks 406, 408, respectively. In a first position or state, the first and second outlet valves 410, 412 prevent a flow of liquid out of the respective holding tank 406, 408. In a second position or state, the first and second outlet valves 410, 412 allow a flow of liquid from the respective holding tank 406, 408 to the respective liquid outlet 414, 416.

In some embodiments, the position or state of the first and second holding tank inlet valves 402, 404 and/or the first and second outlet valves 410, 412 are controlled by a controller 210 as described in regard to FIG. 2. The controller 210 may be located outside of the temperature managed region 204.

The system 400, in one embodiment, provides heated liquid to more than one mixing process. For example, the first liquid outlet 414 may be positioned to dispense liquid to a first mixer (not shown), and the second liquid outlet 416 may be positioned to dispense liquid to a second mixer (not shown).

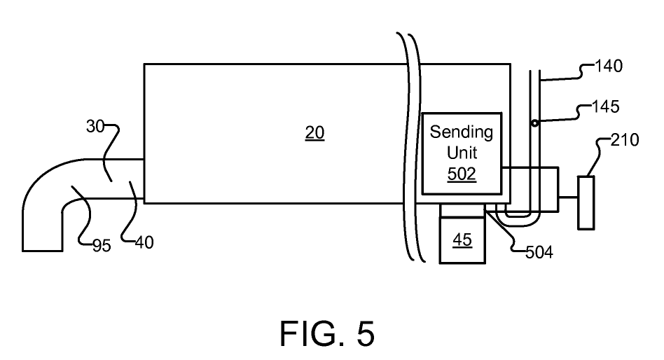

FIG. 5 is a block diagram depicting one embodiment of a holding tank 20 with several types of metering device 135 for measuring an amount of liquid in the holding tank 20. The metering devices 135 include a clear tube 140 with a floating element 145, a submergible sending unit 502, and a weight sensor 504. The metering devices 135 indicate an amount of liquid in the holding tank 20.

The clear tube 140, in one embodiment, extends vertically along an exterior of the holding tank 20 and is liquidly coupled to an interior thereof. The floating element 145 is isolated for vertical movement within the tube 140 on the surface of the liquid that is permitted to rise and fall together with the rise and fall of the liquid within the holding tank 20, thus indicating the level of liquid within the holding tank 20.

The submergible sending unit 502, in one embodiment, is disposed inside of the holding tank 20 and measures a level of liquid in the holding tank 20. The submergible sending unit 502 may be electrically connected to an indicator (not shown) indicating the level of liquid in the holding tank 20. The submergible sending unit 502 may be calibrated using any means, including volume or weight of liquid.

In some embodiments, the weight sensor 504 measures a weight exerted by the holding tank 20 on the support structure 45. The weight sensor 504 may be any type of sensor capable of determining the weight of the holding tank 20 and its contents. For example, the weight sensor 504 may include one or more strain gauges disposed on the support structure 45 that measure a change in strain in the support structure as the amount of liquid in the holding tank 20 varies. In another example, the weight sensor 504 may be a piezo device that generates a current and/or voltage relative to the amount of strain in the piezo device. The weight sensor 504 may be electrically coupled to an indicator that indicates the weight of the liquid in the holding tank 20.

In certain embodiments, the submergible sending unit 502 and/or the weight sensor 504 are/is connected to the controller 210. The controller 210 may be a “smart” controller that, in addition to controlling the flow of liquid into the holding tank 20, determines the amount of liquid in the holding tank 20 and fills the holding tank to a predetermined amount. For example, the controller 210 may be directed to cause the holding tank 20 to contain 25 gallons of liquid. In this example, the controller 210 may open a holding tank inlet valve 128 to allow liquid to flow into the holding tank. A weight sensor 504 may communicate a weight of the tank and its contents to the controller. In response to determining that the weight of liquid in the holding in the holding tank 20 is equivalent to the weight of 25 gallons of the liquid, the controller 210 may close the holding tank inlet valve 128.

Measuring the liquid accurately is critical in some applications. For example, when color is added to mortar, a change in proportions of the ingredients, which may include liquid proportions, can change the color of the mortar and the appearance of the building in which the mortar is being used. The accuracy of the liquid measurement can also affect the quality of the mortar, stucco, or concrete. Therefore, accurate calibration associated with the metering device 135 and the ability of a user or an automated system to accurately control the amount of dispensed liquid can improve the consistency and quality of the mixed product.

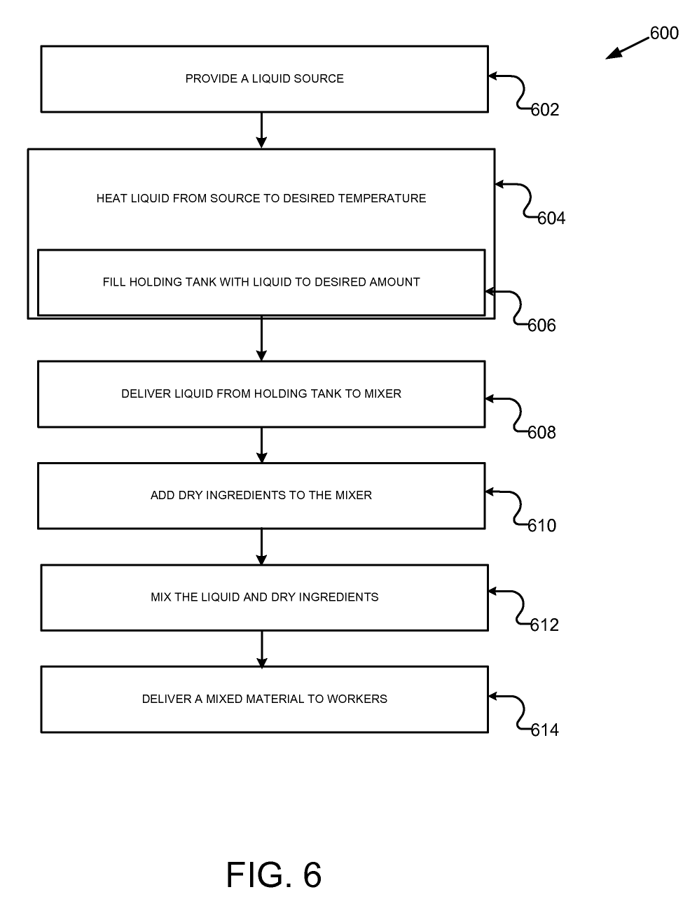

FIG. 6 is a block diagram illustrating a method 600 for adding liquid in a mixing process. The method 600 may include providing 602 liquid from a source. This may include filling a reservoir from a fire hydrant or connecting to a pressurized water source. The method 600 may also include conditioning 604 the liquid, for example, by heating, and/or filling 606 a holding tank 20 to a desired level. Once the liquid in the holding tank 20 has reached a predetermined level, volume, and/or weight, then the liquid is ready for flushing. Thus, the liquid is delivered 608 from the holding tank into a mixer 15. Simultaneously or subsequently, a dry material may be added 610 to the mixer 15. The contents, dry and liquid, can be mixed 612. This process can speed up the heating, liquid delivering, and overall mixing process so that the mixed ingredients can be delivered 614 to workers quickly and in a substantially continuous manner.

An additional step (not shown), may be a preliminary step of warming up the mixer by adding one or more flushes instead of applying a flame of a weed burner to an outside of the mixer barrel. Warming the mixer 15 with hot water from the holding tank has the advantage of warming the mixer 15 faster and avoids the possibility of melting hoses and other parts associated with the mixer 15. In one example, a mixer 15 temperature was raised from approximately ten degrees Fahrenheit to approximately forty degrees Fahrenheit by adding two flushes of hot water from the holding tank 20 within about ten minutes.

It is to be understood that embodiments of the present invention generally include a portable or stationary device to heat or cool pressured or gravity fed water or other liquids utilizing a continuous flow heater 25 or a chiller may be powered by a single or multiple sources including, but not limited to, battery power, solar power, electric power (including alternating current (AC) and/or direct current (DC)), propane, natural gas, oil, other fuels, or any other combustible resource. Also, water or other liquid can be easily routed or imported to the system 200 by a pressured water supply on site or from a reservoir type-tank 27 that will receive pallet forks for the ease of handling. Such a reservoir 27 may be inserted into the insulated enclosure 202 by utilizing a forklift Then water or other liquid may be gravity fed or pumped into the continuous flow heater 25 or other heating unit.

The device may deliver volumes measured by weight of any liquid including, but not limited to water. The liquid may be dispensed at quick flow rates by gravity or under pressure from a pump 50 or pressurized tank 55 or pressurized supply line such as line 30 when pressurized, and may be controlled by an outlet valve 125 connected to a delivery tube such as an enlarged portion of line 30 for delivery of such liquids. In a matter of seconds, the liquid can be dispensed out of an insulated, measured volume tank 20. For example, the needed liquid may be dispensed in a period from approximately one to five seconds. In another embodiment, the liquid is dispensed in a period less than three seconds. In still another embodiment, the liquid is delivered within a period less than approximately one and a half seconds. The outlet valve 125 may simultaneously or subsequently be closed and a process for the heating a liquid in the reservoir and/or refilling the holding tank 20 with a liquid may be started again. When the required amount of liquid is delivered to the holding tank 20, the heated liquid may be stopped by a float (not shown) connected to a lever arm (not shown), which in turn is operably connected to a holding tank inlet valve 128 in the line 30 connected upstream of the holding tank 20.

In one embodiment, when the outlet valve 125 is opened, the holding tank inlet valve 128 is simultaneously closed. Both valves 125, 128 can be actuated at the same time through the motion of a single valve lever controlled by a human and/or mechanical operator. Actuating both valves 125, 128 simultaneously inhibits liquid from entering the holding tank 20 during ejection of the liquid therefrom into the mixer barrel 14. In response to emptying the holding tank 20, the outlet valve 125 can be closed. Closing the outlet valve 125 may automatically open the holding tank inlet valve 128 and the filling and/or heating process of a new batch of liquid is started again. Where the holding tank 20 is inside the enclosure 60, a cable may be connected to the control lever of the valve(s) 125, 128 through a wall of the enclosure 60 such that an operator can manipulate the valves 125, 128 from outside the enclosure by pulling up or down on the cable. Alternatively, a cable or linkage can be connected to the control lever and extend outside the enclosure 60 such that an operator can actuate the valves by pushing or pulling the cable or linkage.

In one embodiment, the system 10 for adding heated liquid in a mixing process may include a flush and dump apparatus that together with the overall system 10 is portable. The system 10 may include an insulated portable structure such as enclosure 60 for housing one or more of the holding tank 20, the pressure control tank 55, and the continuous flow heater 25. The structure may be adjustable in height to raise and/or lower the holding tank 20 for selectively providing gravity flow of liquid therefrom. The holding tank 20 may include the metering device 135 for metering liquid and/or the maximum volume in the holding tank 20 may be adjustable. The holding tank 20 may include an automatic shutoff valve such as the holding tank inlet valve 128. This holding tank inlet valve 128 may be controlled by a float (not shown). The valves 125, 128 may include one or more outlet valves 125 that can be opened or closed simultaneously and either automatically or with a single manual push or pull action. Alternatively, plural valves 125, 128 may be opened or closed individually. The system 10 may also include one or more continuous flow heater(s) 25 with manual or electrical valves and ignitions that are controlled by one or more of wired switches, remote switches, wireless switches, and/or solenoids. The controls for these valves and ignitions may be operated with one or more of 12 volt, 24 volt, 120 volt, and 240 volt AC or DC power, for example, without limitation.

### Masonry Application Example

In one embodiment, the continuous flow heater 25 heats water or other liquid at the rate of 5 to 10 gallons per minute (GPM) with a 70-degree temperature rise at 5000 feet elevation. It is to be understood that the higher the elevation the less GPM and temperature rise. Optimum working temperatures for a mortar may be in a range from 70 to 80 degrees Fahrenheit. Thus, in a situation where an outside temperature is 15 degrees Fahrenheit, the liquid can be dispensed from the holding tank into the mixing drum at approximately 108 to 110 degrees F.

By the time the mortar is mixed and placed on the mud board it will be approximately 70 to 75 degrees. In cold weather, a mason may even heat the wall before striking a new mortar joint. With heated mortar produced by the system 10, the mortar will have more heat that will be transferred to the existing wall and the bricks or blocks being laid. Heating the water and the mortar in this way allows the masons or brick/block installers to have time to use the mortar and place it in the walls prior to the mortar reaching its minimum working temperature. Considering a typical scenario in which ten masonry installers use up approximately 10 cubic feet of mortar every 15 minutes on average throughout the day, embodiments of the present invention have the advantage of heating water at a rate of 5 to 10 gallons per minute and being able to continuously deliver mixed batches of mortar to the mud boards at rates of 10 to 20 cubic feet every 15 minutes.

As may be appreciated, the system and method may be utilized with unheated liquid without heating by the heating apparatus. Furthermore, the system and method may include cooling liquid instead of heating. The system and method may include utilizing one or more solenoid controlled valve to dispense the water or other liquid. The solenoid(s) may be controlled by an electrical device, such as by a switch and/or a timer. The switch may be operatively coupled to a scale such that the solenoid will open the valve when a predetermined weight of the liquid is detected. Still further, embodiments of the invention may include variable or adjustable flow of hot and/or cold liquid in the various portions of the system.

While the system has been described in terms of a tall silo for holding and injecting the dry materials into a mixer 15, it is to be understood that the system may instead include a Quickcrete™ type silo that has a main bin at approximately two or three feet elevation above a ground level. This type of silo utilizes an auger to draw the dry material up and into the mixer 15. Furthermore, it is to be understood that the system may include a greater or lesser number of components than those shown and described herein. For example, the system may not include a dry material silo in some embodiments. In this case, dry material, such as a premixed material, or various ingredients such as sand, cement, and/or gravel may be added directly from bags or by shovel.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for adding a liquid in a mixing process, the apparatus comprising:
a liquid inlet;
a continuous flow heater coupled to the liquid inlet;
a holding tank adapted to be coupled to the continuous flow heater and to receive heated liquid from the continuous flow heater;
a support structure configured to support the holding tank and the continuous flow heater; and
a metering device coupled to the holding tank, the metering device identifying an amount of liquid dispensed from the holding tank.

2. The apparatus of claim 1, wherein the support structure comprises:
an insulated enclosure comprising a temperature managed region;
wherein the holding tank is disposed within the temperature managed region.

3. The apparatus of claim 2 further comprising a space heater disposed within the temperature managed region.

4. The apparatus of claim 2, further comprising:
an outlet valve coupled to the holding tank, the outlet valve having a flow path diameter of at least three inches;
wherein the outlet valve is disposed within the temperature managed region; and
a liquid outlet coupled to the outlet valve to release liquid from the holding tank.

5. The apparatus of claim 4, further comprising a controller coupled to the outlet valve, the controller configured to actuate the outlet valve, the controller disposed outside of the temperature managed region.

6. The apparatus of claim 4, wherein the outlet valve in operation enables a flow of liquid out of the holding tank at a rate in the range of between about 1 and 15 gallons per minute.

7. The apparatus of claim 4, wherein the outlet valve in operation enables a flow of liquid out of the holding tank at a rate in the range of between about 5 and 10 gallons per minute.

8. The apparatus of claim 1, further comprising a pump coupled to the continuous flow heater.

9. The apparatus of claim 1, wherein the continuous flow heater is a first continuous flow heater, and further comprising a second continuous flow heater coupled to the first continuous flow heater, the second continuous flow heater to deliver heated liquid to the holding tank.

10. The apparatus of claim 1, wherein the continuous flow heater is a first continuous flow heater, and further comprising a second continuous flow heater coupled to the liquid inlet, the second continuous flow heater to deliver heated liquid to the holding tank.

11. The apparatus of claim 1, further comprising a holding tank inlet valve coupled to the holding tank, the holding tank inlet valve configured to be moved between a first position for allowing liquid flow from the continuous flow heater into the holding tank and a second position for preventing liquid flow from the continuous flow heater into the holding tank.

12. The apparatus of claim 1, further comprising:
a bypass line coupled to the holding tank, the bypass line configured to conduct water from liquid inlet to the holding tank; and
a bypass valve coupled to the bypass line, the bypass valve configured to be moved between a first position for preventing liquid flow through the bypass line, and a second position for directing liquid flow through the bypass line.

13. A system for adding a liquid in a mixing process comprising:
a portable insulated enclosure having an internal temperature managed region, the enclosure comprising:
a pump;
a continuous flow heater coupled to the pump;
a holding tank adapted to be coupled to the continuous flow heater and to receive heated liquid from the continuous flow heater;
a support structure configured to support the holding tank at a height greater than approximately four feet above a ground level; and
a metering device coupled to the holding tank, the metering device identifying an amount of liquid present in the holding tank, and the amount of liquid dispensed.

14. The system of claim 13, further comprising a power source coupled to the pump, wherein the power source comprises at least one of a generator, a battery, a solar cell, or a wind turbine.

15. The system of claim 13, wherein the pump supplies pressure to the liquid that results in delivering heated liquid to the holding tank at a rate of equal to or greater than approximately five gallons per minute, and wherein the continuous flow heater is capable of raising the temperature of the liquid delivered to the holding tank by ninety degrees Fahrenheit.

16. The system of claim 13, wherein the holding tank is a first holding tank, and further comprising a second holding tank adapted to be coupled to the continuous flow heater and to receive heated liquid from the continuous flow heater.

17. The system of claim 13, further comprising an auxiliary heated liquid outlet coupled to the continuous flow heater, the auxiliary heated liquid outlet disposed outside the temperature managed region.

18. The system of claim 13, further comprising a dry material supply bin for supplying at least one of cement, sand, concrete, mix, or gravel to a mixer, the material supply bin supported on a support stand that locates the dry material supply bin at a height greater than or equal to approximately three feet from a ground level.

19. A method for supplying liquid to a mixer, the method comprising:
heating liquid with a continuous flow heater at a rate greater than or equal to approximately five gallons per minute;
delivering the heated liquid to a holding tank at a rate greater than or equal to approximately five gallons per minute;
managing the amount of liquid in the holding tank to be approximately a predetermined amount; and
delivering the liquid in the holding tank to a mixer at a rate of greater than or equal to approximately five gallons per second.

20. The method of claim 19, wherein heating the liquid comprises raising the temperature by at least ninety degrees Fahrenheit.
